(19) United States
(12) Patent Application Publication
(10) Pub. No.: US 2004/0027365 A1
(43) Pub. Date: Feb. 12, 2004

(54) Controlling playback of a temporal stream with a user interface device

(76) Inventors: Craig P. Sayers, Menlo Park, CA (US); Bernard J. Burg, Menlo Park, CA (US)

Correspondence Address: HEWLETT-PACKARD COMPANY, Intellectual Porperty Administration, P.O. Box 272400, Fort Collins, CO, 80527-2400, US

(21) Appl. No.: 10/213,971

(22) Filed: Aug. 7, 2002

(51) Int. Cl. G09G 5/00

(52) U.S. Cl. 345/700; 345/720

(57) ABSTRACT

A method for controlling playback of a temporal stream with a user interface device. The temporal stream is captured at an event site. A point of interest at the event site is selected with the user interface device. A time that an action occurred at the selected point of interest is identified. An image from the temporal stream is identified based on the identified time. The identified image is displayed on the user interface device.

### THE FIELD OF THE INVENTION

The present invention relates to user interface devices, and more particularly, relates to controlling playback of a temporal stream with a user interface device.

### BACKGROUND OF THE INVENTION

There are several existing devices for viewing images from a temporal stream (e.g., a video stream). Video data recorders are well known. Initially, video data recorders were designed to record video signals on videotape and allow playback of recorded video signals from the tape. Videotapes use sequential recording and playback, limiting the functionality of such machines. Disk-based video playback machines have been introduced, such as video disk and digital video disk machines. These machines may generally be characterized as providing a removable, randomly accessible disk allowing for the storage and playback of video signals. Other machines, such as computers and personal video recorders, use a hard drive for digitally storing temporal streams and providing random access to images in the streams.

Existing techniques for providing temporal control during the playback of a video stream include jog dials, and forward/reverse scan buttons. A jog dial is a dedicated, specialized transducer for issuing time commands. A jog dial is typically implemented as a physical knob that controls video playback according to the knob's position along its one dimension of rotational freedom. For example, a user can move the knob forward a small amount to advance a few frames in the temporal stream, or spin the knob forward to advance several frames in the temporal stream. Forward and reverse scan buttons are typically used to sequentially scan forward and backward through a temporal stream. With conventional jog dials, and forward and reverse buttons, it is often inefficient to identify images that a user is interested in.

In some other existing systems, such as virtual reality systems, the spatial position and/or viewpoint of the user is used to control imagery. In these systems, there is typically a direct mapping between physical motion in the real world and spatial motion in the virtual world. For example, if the user moves his viewpoint one unit to the left, then the virtual reality image moves one unit to the right.

It would be desirable to provide a more efficient and natural user interface device for controlling a temporal stream.

### SUMMARY OF THE INVENTION

One form of the present invention provides a method for controlling playback of a temporal stream with a user interface device. The temporal stream is captured at an event site. A point of interest at the event site is selected with the user interface device. A time that an action occurred at the selected point of interest is identified. An image from the temporal stream is identified based on the identified time. The identified image is displayed on the user interface device.

### BRIEF DESCRIPTION OF THE DRAWINGS

FIG. 1 is a simplified perspective view illustrating major components of a temporal stream capture and playback is system according to one embodiment of the present invention.

FIG. 2 is a block diagram illustrating major components of the temporal stream capture and playback system shown in FIG. 1 according to one embodiment of the present invention.

FIG. 3 is an electrical block diagram illustrating major components of the server shown in FIGS. 1 and 2 according to one embodiment of the present invention.

FIG. 4A is a diagram illustrating a time database according to one embodiment of the present invention.

FIG. 4B is a diagram illustrating a video database according to one embodiment of the present invention.

FIG. 5A is a diagram illustrating a simplified front view of a user interface device according to one embodiment of the present invention.

FIG. 5B is a diagram illustrating a simplified back view of user interface device according to one embodiment of the present invention.

FIG. 6A is an electrical block diagram illustrating major components of a user interface device according to one embodiment of the present invention.

FIG. 6B is an electrical block diagram illustrating major components of an alternative embodiment of a user interface device.

FIG. 7 is a flow diagram illustrating a process for controlling the playback of a temporal stream according to one embodiment of the present invention.

FIG. 8 is a flow diagram illustrating a process for controlling the playback of a temporal stream according to an alternative embodiment of the present invention.

FIG. 9 is a flow diagram illustrating a process for controlling the playback of a temporal stream with a combined recording and playback device according to one embodiment of the present invention.

FIG. 10A is a diagram illustrating a video stream captured by a user interface device according to one embodiment of the present invention.

FIG. 10B is a diagram illustrating the identification of a point of interest according to one embodiment of the present invention.

FIG. 10C is a diagram illustrating the identification of a set of image frames that include a point of interest identified by a user according to one embodiment of the present invention.

FIG. 10D is a diagram illustrating the identification of frames that show motion near a selected point of interest according to one embodiment of the present invention.

FIG. 10E is a diagram illustrating a frame selected for display according to one embodiment of the present invention.

FIG. 10F is a diagram illustrating the display of a relevant image portion of an image frame identified during the process shown in FIG. 9 according to one embodiment of the present invention.

### DESCRIPTION OF THE PREFERRED EMBODIMENTS

In the following detailed description of the preferred embodiments, reference is made to the accompanying drawings, which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims.

In one form of the invention, the physical position and/or motion of a portable user interface device is mapped to a spatial location, and that spatial location is used to access a temporal location in a temporal stream (e.g., video stream). One embodiment of the present invention provides a portable user interface device that allows a user to control the playback of a video stream by using the spatial location of the user's viewpoint, which is much more efficient than conventional temporal scanning methods. For example, for a video stream showing a running race with hurdles, it is difficult and inefficient to fast forward and rewind during playback of the stream to find the point in time at which a given runner reached a certain spatial location on the track (e.g., jumped over a certain hurdle). In contrast, it is relatively easy to point to that hurdle with a portable device. In one embodiment, identifying the hurdle with the portable device automatically causes an appropriate image from the video stream to be displayed, such as an image of a runner jumping over that hurdle. In one form of the invention, the portable device provides a very natural interface for selecting segments from a time-varying video stream. In one embodiment, the portable device provides users with personalized slow motion replays, and the ability to select images to store and send to other users.

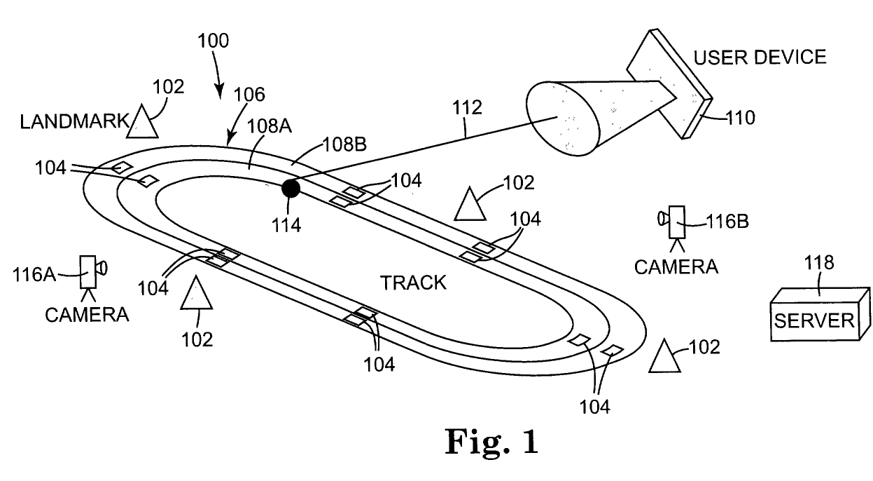

FIG. 1 is a simplified perspective view illustrating major components of a temporal stream capture and playback system 100 according to one embodiment of the present invention. System 100 includes a plurality of motion sensors 104, a portable user interface device 110, a plurality of cameras 116A-116B (collectively referred to as cameras 116), and a server 118. Although a single device 110 is shown in FIG. 1, in another embodiment, system 100 includes a plurality of portable user interface devices 110.

As shown in FIG. 1, system 100 is being used at a running track 106 for capturing and playing back images of a running race. Running track 106 includes running lanes 108A and 108B. A plurality of landmarks 102 surround running track 106. It will be understood by persons of ordinary skill in the art that capturing and playing back images of an event, such as a running race, at an event site, such as a running track, is merely one example of the many potential uses of system 100.

Cameras 116 each capture a temporal stream of images of runners going around running track 106. In one embodiment, the captured images are transmitted by cameras 116 to server 118. In one form of the invention, server 118 transmits a temporal stream to one or more portable user devices 110, which are configured to display the received images.

In one embodiment, the temporal stream received by portable user device 110 is a delayed broadcast of the event. In another embodiment, the temporal stream is a live stream. In yet another embodiment, device 110 itself captures a temporal stream of the event, as described in further detail below.

Motion sensors 104 are positioned at various spatial locations around running track 106. When a runner passes by a particular motion sensor 104, the motion sensor transmits a signal that is received by server 118. In one embodiment, motion sensors 104 are heat sensing motion sensors. In another embodiment, motions sensors 104 are implemented with a set of cameras focused on known locations around the track 106 to identify when particular runners reach particular spatial locations.

In one embodiment, during or after an event, such as a running race, a user selects a particular point of interest with device 110. Device 110 has a viewing axis 112 associated with it. As shown in FIG. 1, device 110 is positioned such that its viewing axis 112 is pointing toward spatial location 114. After a user selects a desired spatial location with device 110, in one embodiment, information for identifying the selected spatial location is transmitted from device 110 to server 118. As described in further detail below, based on the selected spatial location, server 118 identifies a particular image from the temporal streams captured by cameras 116, and transmits the identified image to device 110 for display. In one embodiment, the images transmitted from server 118 to device 110 are synthesized images that match the viewpoint of the user of the device 110.

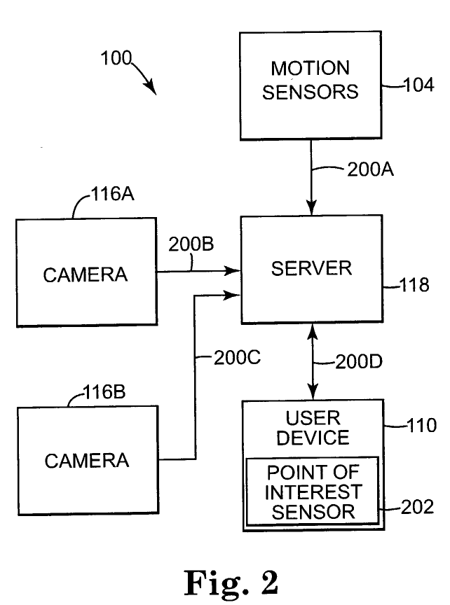

FIG. 2 is a block diagram illustrating major components of the temporal stream capture and playback system 100 shown in FIG. 1 according to one embodiment of the present invention. Motion sensors 104 communicate with server 118 via communications link 200A. Cameras 116A and 116B communicate with server 118 via communications link 200B and 200C, respectively. Device 110 communicates with server 118 via communications link 200D.

In one embodiment, communications links 200A-200D (collectively referred to as communications links 200) are wireless communications links. In alternative embodiments, other types of communication links are used. The video streams transmitted and/or received by server 118 may be carried by any conventional communications medium, including cable, over-the-air broadcast, satellite, and the Internet. In one embodiment, a single video source (e.g., a camera 116 or other video source) provides a video stream to server 118. In another embodiment, multiple video sources (e.g., multiple cameras 116 or other video sources) provide a video stream to server 118.

In one embodiment, device 110 includes a point of interest sensor 202, which detects the spatial location of a point of interest based on the pointing direction of device 110. In one embodiment, point of interest sensor 202 senses the position and orientation of device 110. In one form of the invention, the sensed position and orientation is transmitted from device 110 to server 118. By knowing the position and orientation of device 110, server 118 can determine what spatial location is being addressed by device 110.

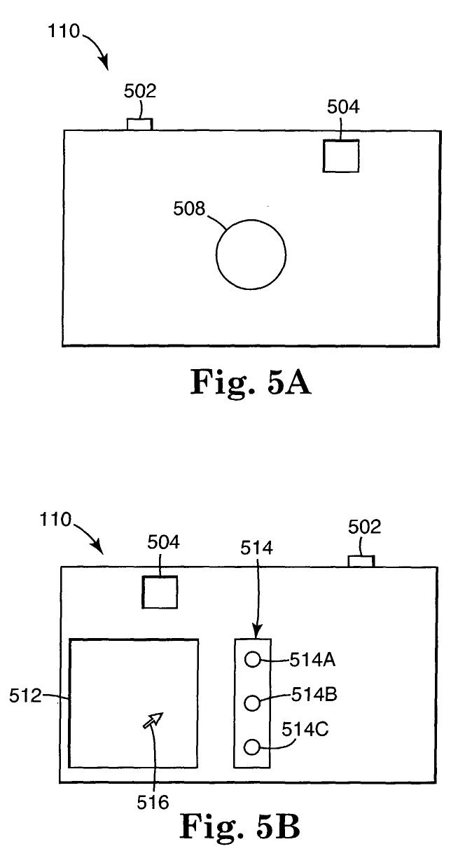

For example, assume that a user of device 110 is at an athletics event, and a 200 meter hurdles race has just finished. The user notices that one of the lanes on the track has several hurdles knocked down, and is curious what happened. The user points device 110 toward the position on the track where the first hurdle was knocked down, and pushes an appropriate button (e.g., button 502, shown in FIGS. 5A and 5B) on the device 110, thereby selecting that position of the track. The selected spatial location is transmitted from device 110 to server 118. In response, server 118 determines the time that the runner reached the selected spatial location, and transmits an image of the selected spatial location at the point in time the runner reached that spatial location. Device 110 receives the transmitted image, which shows the runner knocking down the hurdle.

Similarly, the user can point the device 110 toward various spatial locations before the hurdle, at the hurdle, and after the hurdle to view the runner before, during, and after the hurdle. The user can point the device 110 at a hurdle in another lane to compare the technique of a previously viewed runner with another runner. The user can point the device 110 at the finish line to see images showing how close the finish was. In a multi-lap race, where a runner crosses a given spatial location on the track several times, the user can move his point of interest back one lap by quickly scanning backward around the track, or move forward a lap by quickly scanning forward around the track with device 110. Thus, device 110 can be used for fast forwarding and rewinding through a video stream based on identified spatial locations.

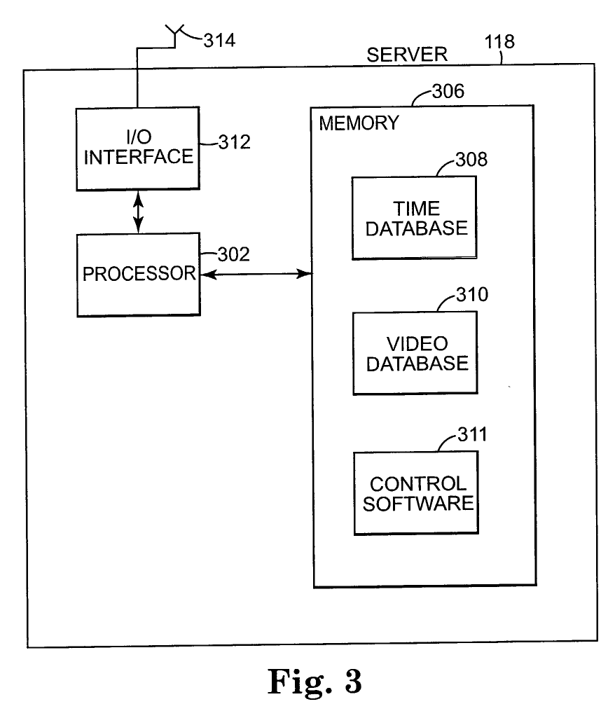

FIG. 3 is an electrical block diagram illustrating major components of server 118 according to one embodiment of the present invention. Server 118 includes processor 302, memory 306, input/output (I/O) interface 312, and antenna 314. A time database 308 and a video database 310 are stored in memory 306. Control software 311 for controlling the operation of processor 302 is also stored in memory 306. In one embodiment, memory 306 includes both volatile and nonvolatile memory. In one form of the invention, memory 306 includes a high capacity, recordable, randomly accessible recording medium such as a hard disk. Use of a randomly accessible recording medium provides certain advantages, such as allowing the simultaneous recording and playback of video signals. Thus, a user of device 110 may view a video stream transmitted by server 118 as the video stream is being recorded by server 118, and take advantage of the spatial location based temporal control functions during recording.

Processor 302 is coupled to memory 306 and I/O interface 312. I/O interface 312 is coupled to antenna 314. Processor 302 receives and transmits video streams via I/O interface 312 and antenna 314, and stores received video streams in the video database 310. In one embodiment, processor 302 stores received images in a digital format to facilitate direct and random access to various parts of the received temporal streams. Processor 302 also sends and receives other communications with device 110, cameras 116, and motion sensors 104, via I/O interface 312 and antenna 314. Data received by server 118 from motion sensors 104 are stored in time database 308.

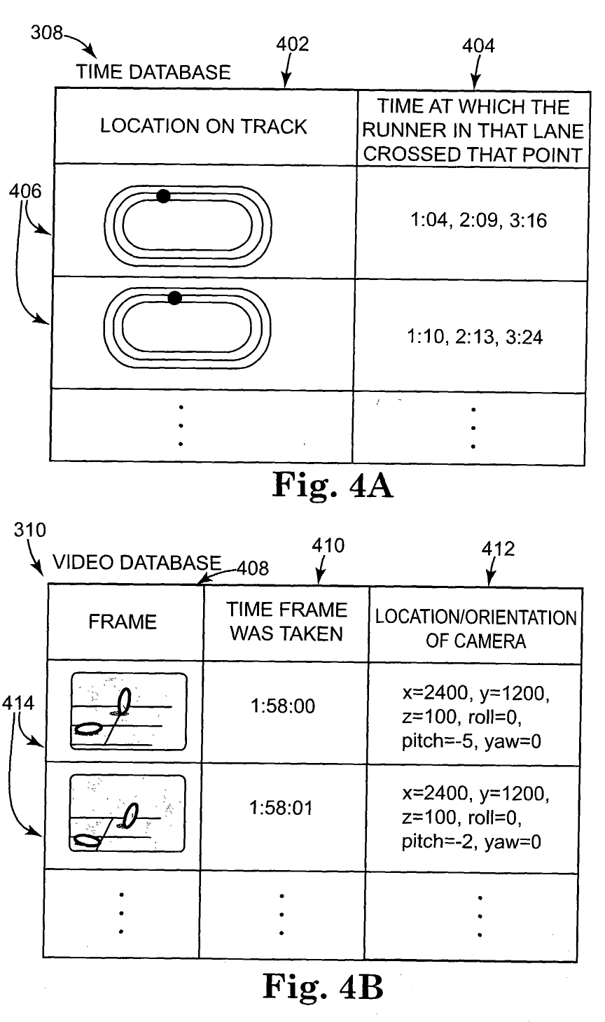

FIG. 4A is a diagram illustrating a time database 308 according to one embodiment of the present invention. Time database 308 includes columns 402 and 404, and a plurality of entries 406. Each entry 406 associates a spatial location at an event site (e.g., a location on a running track) in column 402 with a set of times in column 404 that indicate when certain actions have occurred at the associated spatial location (e.g., times at which a runner has crossed a given spatial location on the running track). Column 402 in FIG. 4A illustrates a graphical representation of spatial locations on a running track. In one embodiment, the spatial locations are stored as numbers representing latitude, longitude, and altitude, for the various locations. In alternative embodiments, other information is used to identify spatial locations. For example, for a running track, spatial locations can be identified by a lane number and distance from a given starting point in that lane.

For a running race, motion sensors 104 (shown in FIGS. 1 and 2) sense the positions of each of the athletes in each lane over time and transmit this motion information to server 118. A mapping is then created by server 118 between each spot on the track and the time that a runner passed that spot on the track, and the mapping is stored in time database 308. For example, for the first entry 406 in FIG. 4A, column 404 indicates that the runner crossed the spatial location shown in column 402 at times 1:04, 2:09, and 3:16. In one embodiment, the motion sensors 104 are spaced apart by a known distance, and interpolation is used to determine time/spatial location information between sensors 104.

When a spatial location is identified by a device 110 and transmitted to server 118, the time database 308 is accessed by processor 302 to determine when a runner crossed that spatial location on the track most recently. The identified time from column 404 is then used by processor 302 to identify an image stored in the video database 310, as described in further detail below.

FIG. 4B is a diagram illustrating a video database 310 according to one embodiment of the present invention. Video database 310 includes columns 408, 410, and 412, and a plurality of entries 414. Each entry 414 associates an image frame (in column 408) from a received video stream, with a time (in column 410) that the image frame was taken by one of cameras 116, and with location and orientation information (in column 412) representing the location and orientation of the camera 116 at the time the camera 116 captured the image frame.

To simplify the illustration, runners on a running track are represented by ovals in FIG. 4B. The illustrated image frames in column 408 show the runner in one of the lanes falling down near the finish line. For the illustrated embodiment, the location of a camera 116 is represented by x, y, and z coordinates, and the orientation of the camera 116 is represented by roll, pitch, and yaw data. In alternative embodiments, other types of position and orientation data are used.

In one embodiment, for each image frame in the video streams transmitted by cameras 116 to server 118, cameras 116 also transmit to server 118 the time that the image frame was taken, and the position and orientation of the camera when the image frame was taken. Processor 302 stores each image frame and the associated time information and location/orientation information in video database 310. If cameras 116 are stationary, the position and orientation data may be predetermined and stored in video database 310, and remains constant for each image frame.

As described above, when server 118 receives a spatial location from device 110, server 118 identifies a time from time database 308 associated with that spatial location. In one embodiment, processor 302 compares the identified time to the times in column 410 of video database 310 to find one or more matching times. In one form of the invention, for each entry 414 with a matching time, processor 302 determines from the location and orientation data in column 412 whether the image frame for that entry 414 includes an image of the received spatial location. If one of the image frames includes an image of the received spatial location, server 118 transmits the image frame to device 110 for display.

FIG. 5A is a diagram illustrating a simplified front view of device 110 according to one embodiment of the present invention. FIG. 5B is a diagram illustrating a simplified back view of device 110 according to one embodiment of the present invention. As shown in FIGS. 5A and 5B, device 110 includes button 502, optical viewfinder 504, lens 508, liquid crystal display (LCD) 512, and user input device 514. User input device 514 includes a plurality of buttons 514A-514C. User input device 514 allows a user to enter data, select various options, and control a screen pointer 516 that is displayed on LCD 512.

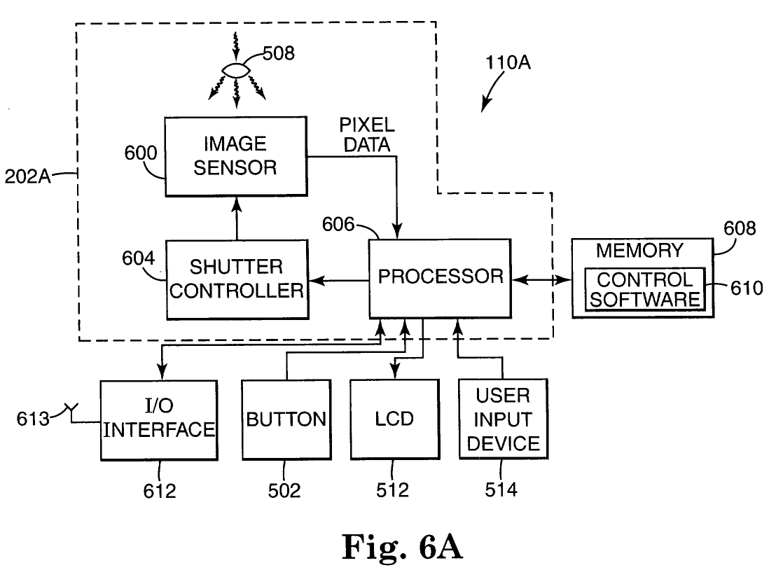

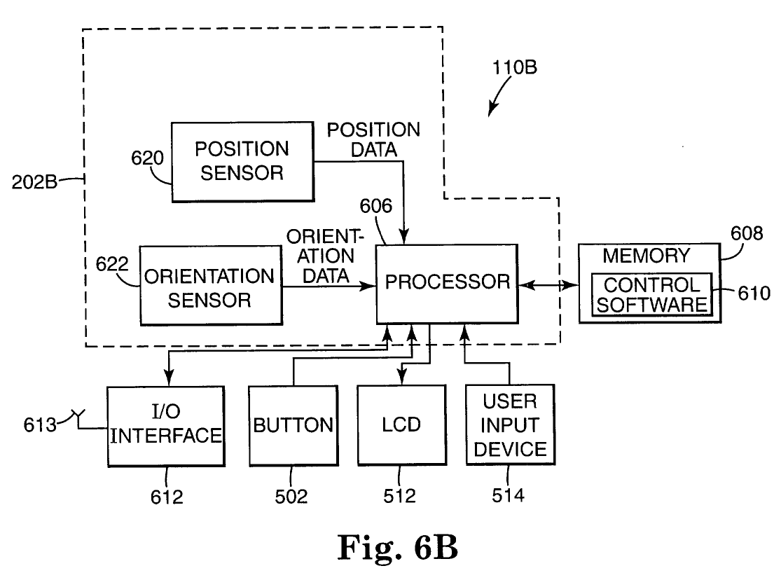

In operation according to one embodiment, a user looks through optical viewfinder 504 or at display 512, and positions device 110 to focus on a point of interest at an event site. When device 110 is in the desired position, the user presses button 502 to capture an image of the point of interest. An optical image is focused by lens 508 onto image sensor 600 (shown in FIG. 6A), which generates pixel data that is representative of the optical image. Images captured by device 110 are displayed on display 512. In addition, images received from server 118 are also displayed on display 512.

FIGS. 6A and 6B illustrate two embodiments of device 110. FIG. 6A illustrates one embodiment, which is identified by reference number 110A. FIG. 6B illustrates another embodiment, which is identified by reference number 110B. Devices 110A and 110B are referred to generally herein as device 110.

FIG. 6A is an electrical block diagram illustrating major components of device 110A according to one embodiment of the present invention. Device 110A includes lens 508, image sensor 600, shutter controller 604, processor 606, memory 608, input/output (I/O) interface 612, antenna 613, button 502, LCD 512, and user input device 514. In one embodiment, memory 608 includes some type of random access memory (RAM) and non-volatile memory, but can include any known type of memory storage. Control software 610 for controlling processor 606 is stored in memory 608.

In one embodiment, a point of interest sensor 202A is implemented in device 110A by lens 508, image sensor 600, shutter controller 604, and processor 606. In operation according to one embodiment, when a user presses button 502, processor 606 and shutter controller 604 cause image sensor 600 to capture an image of the desired point of interest. Image sensor 600 then outputs pixel data representative of the image to processor 606. The pixel data or image is transmitted from device 110A to server 118 via I/O interface 612 and antenna 613. Captured images may also be displayed on display 512.

In one embodiment, server 118 processes the received image using conventional computer vision techniques to determine the spatial location of the point of interest. Landmarks 102 (shown in simplified form in FIG. 1), which may include naturally occurring landmarks and/or specially placed markers, may be used to facilitate spatial location identification using image processing techniques. In one form of the invention, based on the image received from device 110A, server 118 transmits an image frame from a temporal stream to device 110A for display on display 512.

In addition to allowing device 110A to receive information from and transmit information to server 118, I/O interface 612 and antenna 613 are used by device 110A to communicate with other similar user interface devices 110.

FIG. 6B is an electrical block diagram illustrating major components of device 110B. In the illustrated embodiment, point of interest sensor 202B is implemented with position sensor 620, orientation sensor 622, and processor 606. Position sensor 620 senses the position of device 110B and sends corresponding position data to processor 606. Orientation sensor 622 senses the orientation of device 110B and sends corresponding orientation data to processor 606. When a user points device 110B at a desired point of interest and presses button 502, processor 606 transmits the current position and orientation data to server 118 via I/O interface 612 and antenna 613. Server 118 then identifies the spatial location of the point of interest based on the received position data and orientation data, and transmits an appropriate image frame from a temporal stream, which includes the identified spatial location, to device 110 for display on display 512. Point of interest sensors 202A and 202B are referred to generally herein as point of interest sensor 202.

As mentioned above, the embodiment of point of interest sensor 202 illustrated in FIG. 6B (i.e., point of interest sensor 202B) senses the position and orientation or pointing direction of device 110B. Although convenient position measurement units might be latitude, longitude, and altitude, other position measurement units may also be used. In an alternative embodiment, the position of device 110B is determined from the seat location of the user of device 110B, and position sensing is not used. When point of interest sensor 202 is configured to sense position, the user of device 110B can wander at will throughout a stadium and make use of the services provided by server 118 from any viewpoint. In one embodiment, the orientation measurement units used by orientation sensor 622 are roll, pitch, and yaw, although alternative embodiments may use other orientation measurement units. Point of interest sensor 202B may be implemented with a variety of different readily available sensors, including global positioning system (GPS) receivers, radio triangulation devices, compasses, laser gyroscopes, as well as other sensors.

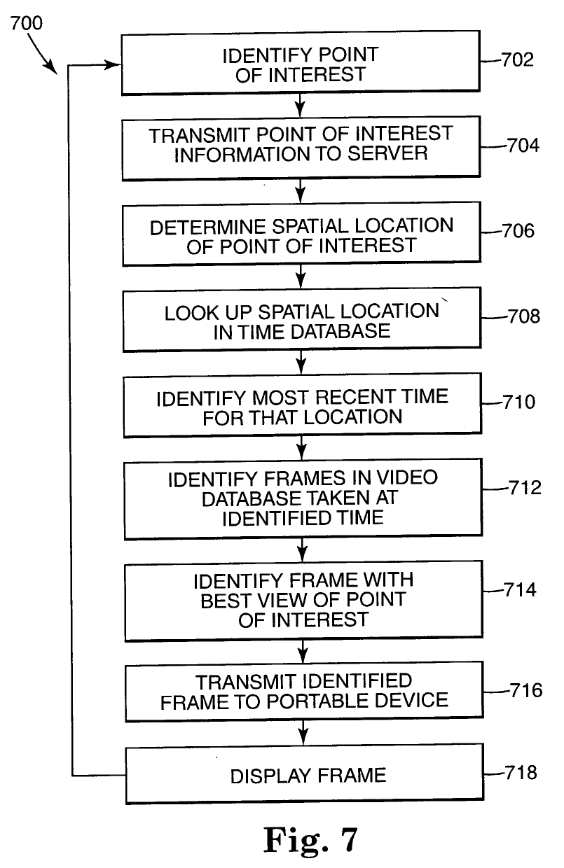

FIG. 7 is a flow diagram illustrating a process 700 for controlling the playback of a temporal stream according to one embodiment of the present invention. For process 700, it is assumed that the user of device 110 is at the event site (e.g., a stadium) of a particular event, such as a running race, and that a video stream of the event has been stored in server 118 as described above.

In step 702, a user identifies a point of interest with device 110. In one embodiment, the point of interest is identified based on a captured image of the point of interest (see, e.g., FIG. 6A and corresponding description). In another embodiment, the point of interest is identified based on the position and orientation of device 110 (see, e.g., FIG. 6B and corresponding description). In step 704, device 110 transmits point of interest information to server 118.

In step 706, server 118 determines the spatial location of the point of interest. In one embodiment, if the point of interest is identified by an image transmitted to server 118, server 118 processes the image using conventional computer vision techniques, including looking for landmarks 102 appearing in the image, to determine the spatial location of the point of interest. In another embodiment, if the point of interest is identified by position and orientation data, the spatial location is determined by server 118 based on the position and orientation of device 110.

In step 708, server 118 looks up the spatial location in column 402 of time database 308. In step 710, server 118 identifies the most recent time for that spatial location from column 404 of time database 308. In step 712, server 118 identifies image frames in video database 310 taken at or near the time identified in step 710. In one embodiment, multiple cameras 116 capture image frames of an event, so multiple image frames may be taken at about the same time instant.

In step 714, server 118 identifies an image frame from the set of frames identified in step 712 with the best view of the point of interest. In one embodiment, the best view is determined by server 118 from the position and orientation data associated with each of the image frames in column 412 of video database 310.

In step 716, server 118 transmits the image frame identified in step 714 to device 110. In step 718, device 110 displays the received image frame on display 512. The process 700 may then be repeated for any other points of interest selected by the user of device 110, thereby allowing the user to move forward and/or backward through the temporal stream by moving device 110 and selecting various points of interest at the event site. In one embodiment, button 502 of device 110 may be held down by a user to continuously select points of interest as the device 110 is moved by the user.

In one embodiment, the image transmitted to device 110 in step 716 is one of the images captured by one of the cameras 116. In another embodiment, the image transmitted to device 110 is a synthesized image generated by server 118 from the images captured by cameras 116. In one form of the invention, the synthesized image represents a view of the event from the perspective of the user's location. View interpolation techniques for generating such synthesized images are known to those of ordinary skill in the art. View interpolation is a known computer vision technique that, generally speaking, takes a first view from a first camera and a second view from a second camera and synthesizes an image that appears to have been taken by a camera that was positioned somewhere between the first two cameras. Using this technique, given enough real physical cameras, a view can be synthesized from a “virtual camera” in any desired position at the event site. In one embodiment, the position and orientation of the cameras 116 capturing an event are stored in video database 310 (e.g., in column 412) and used for view interpolation.

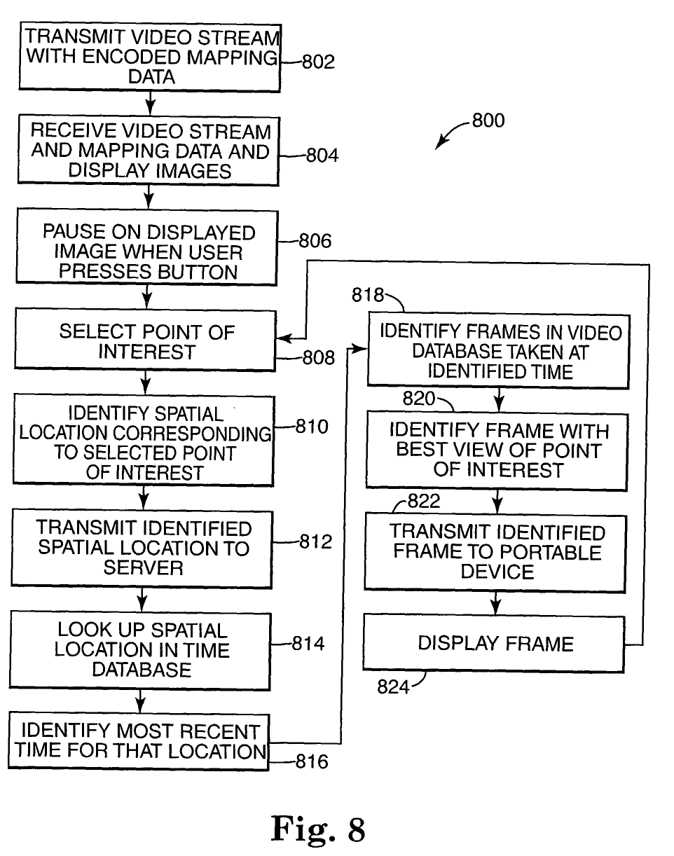

FIG. 8 is a flow diagram illustrating a process 800 for controlling the playback of a temporal stream according to an alternative embodiment of the present invention. For process 800, it is assumed that the user of device 110 is not at the event site of an event being recorded, and that a video stream of the event has been stored in server 118.

In step 802, server 118 transmits a video stream of an event to device 110. In one embodiment, encoded within the transmitted video stream is a mapping between regions (e.g., pixels) in the image frames and spatial locations at the event site. For the running race example, the video stream would include a mapping between pixels in the image frames and locations on the running track. The video may be transmitted by server 118 to device 110 using any conventional transmission system, including satellite, cable, over the air broadcasts, and the Internet.

In step 804, the user receives the transmitted video stream with device 110 and displays the received images on display 512. In step 806, when the user pushes button 502 on device 110, device 110 freezes on the currently viewed image. After pausing on an image, the user is provided with immediate access to other images of the event by selecting a desired point of interest in the currently viewed image.

In step 808, a user selects a point of interest using device 110. In one embodiment, the user selects a point of interest by moving screen pointer 516 (shown in FIG. 5B) with user input device 514 to a desired region (e.g., pixel) in the currently viewed image and “clicks” on that point of interest by pushing button 502 or other appropriate select button.

In step 810, device 110 identifies the spatial location corresponding to the selected pixel based on the spatial information encoded in the received video stream. In step 812, device 110 transmits the identified spatial location to server 118.

In step 814, server 118 looks up the spatial location in column 402 of time database 308. In step 816, server 118 identifies the most recent time for that spatial location from column 404 of time database 308. In step 818, server 118 identifies image frames in video database 310 taken at or near the time identified in step 816. In one embodiment, multiple cameras 116 capture image frames of an event, so multiple image frames may be taken at about the same time instant.

In step 820, server 118 identifies an image frame from the set of frames identified in step 818 with the best view of the point of interest. In one embodiment, the best view is determined by server 118 from the position and orientation data associated with each of the image frames in column 412 of video database 310.

In step 822, server 118 transmits the image frame identified in step 820 to device 110. In step 824, device 110 displays the received image frame on display 512. The process 800 may then be repeated for any other points of interest selected by the user of device 110.

As an example of process 800, assume that a user is watching a video stream of a running race on display 512, hits button 502 when the user sees the runner in lane 1 crossing the finish line, and the user wants to see the point in the video stream when the runner in lane 3 crosses the finish line. The user clicks on lane 3 in the displayed image at the point near the finish line. Device 110 identifies the spatial location corresponding to the selected point based on the encoded information in the video stream, and transmits the identified spatial location to server 118. Based on the received spatial location, server 118 identifies an appropriate image in the temporal stream, and transmits that image to device 110. Device 110 displays the image on display 512, which shows the runner in lane 3 crossing the finish line. The user can then click on a spot in the received image, and receive another image, and repeat the process as often as desired.

In one embodiment, where the transmitted video stream is a delayed broadcast, since the times shown in column 404 of FIG. 4A corresponding to each spatial location at the event site are known at the time the stream is transmitted, each pixel in each image transmitted by server 118 to device 110 is associated with an appropriate one of the times. So the mapping between each pixel in an image and the temporal location in the video stream is determined prior to transmission and is encoded in the video stream. In this embodiment, when the user clicks on a pixel in the displayed image (e.g., step 808 of process 800), device 110 identifies the time corresponding to the selected pixel and transmits the time to server 118. Server 118 then looks up that time in video database 310, and transmits an appropriate image to device 110 for display. In contrast, for a live broadcast, if an image is showing the lead runner in lane two, for example, it may not be known yet when the runner in lane three is going to cross that same region of the track. Thus, in one embodiment, for a live broadcast, each pixel is associated with a spatial location rather than a time.

In another embodiment, rather than selecting a point of interest by clicking on a point in a displayed image, the orientation of device 110 is determined by point of interest sensor 202B, and the point of interest is determined based on the orientation of device 110 when the user pushes button 502. In this embodiment, a virtual reality representation of the event site is transmitted by server 118 to device 110. As the user moves device 110, the images displayed on display 512 correspondingly change. Thus, in this embodiment, it appears to the user as if he were actually at the event site, and essentially the same technique as described above with reference to FIG. 7 is used to select a point of interest (e.g., position device 110 to center on a desired point of interest in a displayed virtual reality image, and pushing button 502 to select that point of interest). The selected point of interest is transmitted to server 118, and server 118 returns an appropriate image from the temporal stream based on the selected point of interest. In this embodiment, point of interest sensor 202B senses the orientation of device 110, but not the position of device 110. The user of device 110 is assumed to be at a particular position at the event site, and receives virtual reality views of the site from that position.

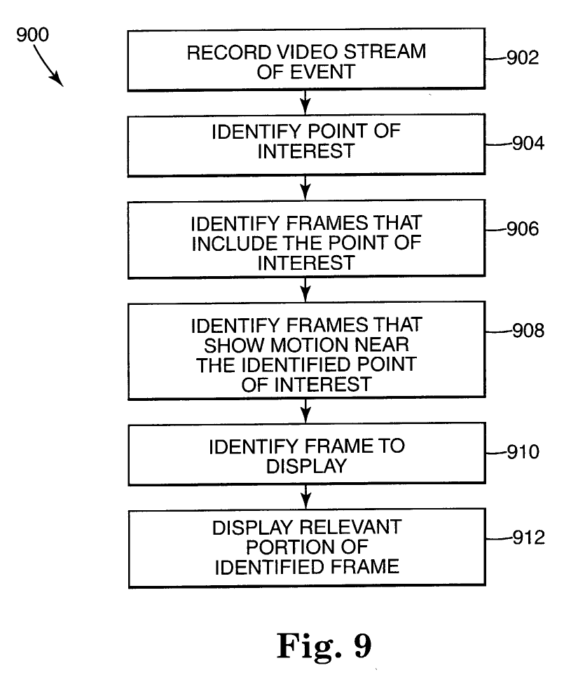

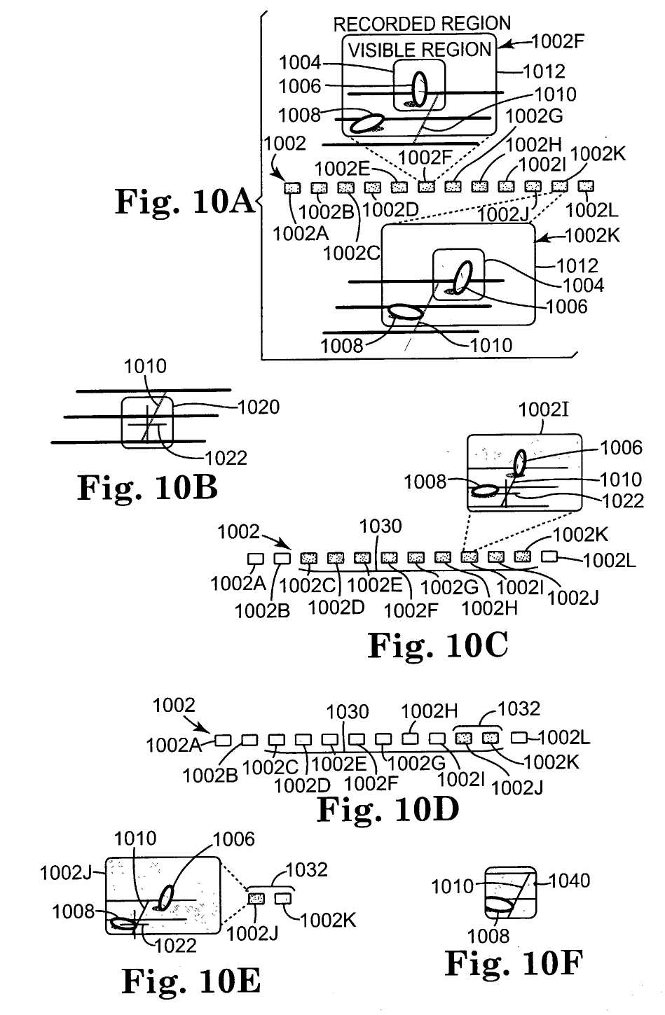

In one embodiment, device 110 is both a recording device for capturing a video stream of an event, and a playback device for viewing the previously captured video stream. In one form of the invention, image sensor 600 (shown in FIG. 6A) of device 110 captures images of an event at a higher resolution and a wider field of view than is visible to the user with viewfinder 504 or display 512. For example, as a user is sitting in the stands recording a running race with device 110, the user might be focusing on the lead runner all the way around the track, and does not see the other runners. But in one embodiment, the images that are captured by image sensor 600 have a higher resolution and a wider field of view than what is viewed by the user, and include more information than just the lead runner. In one form of the invention, the user is provided access to that extra information that was recorded by device 110, but that the user did not see while the event was occurring and being recorded, as described in further detail below with reference to FIGS. 9 and 10A-10F.

FIG. 9 is a flow diagram illustrating a process 900 for controlling the playback of a temporal stream with a combined recording and playback device according to one embodiment of the present invention.

In step 902, the user records a video stream of an event, such as a running race, with device 110. FIG. 10A is a diagram illustrating a video stream 1002 captured by device 110 according to one embodiment of the present invention. As shown in FIG. 10A, video stream 1002 includes a plurality of image frames 1002A-1002L. Image frames 1002F and 1002K are shown enlarged in FIG. 10A to illustrate example image content. The actual amount of information that was recorded for image frames 1002F and 1002K is represented by boundary 1012, and the image information that was visible to the user during recording (e.g., through viewfinder 504 or display 512) is represented by boundary 1004. As shown in FIG. 10A, runner 1006 (shown in simplified form as an oval near finish line 1010) is within boundary 1004 in frames 1002F and 1002K, and was visible to the user during recording, but runner 1008 is outside boundary 1004 and was not visible to the user during recording. Runner 1008 is within boundary 1012 and was part of the image content of frames 1002F and 1002K.

Referring to FIG. 9, after video stream 1002 of the event has been recorded by device 110, in step 904, the user identifies a point of interest with device 110. FIG. 10B is a diagram illustrating the identification of a point of interest according to one embodiment of the present invention. Image 1020 in FIG. 10B represents the view seen by the user through viewfinder 504 or display 512 of device 110. In one embodiment, cross hairs 1022 are provided in the view to facilitate a more precise identification of the point of interest. As shown in FIG. 10B, the user has positioned device 110 to focus on the lane that was occupied by runner 1008 near the finish line 1010. After positioning device 110 to focus on the desired point of interest, the user presses button 502 to capture an image of the point of interest.

In step 906 of process 900, device 110 identifies image frames in the recorded video stream 1002 that include the point of interest identified in step 904. In one embodiment, processor 606 (shown in FIG. 6A) of device 110 compares the captured image that includes the point of interest to the image frames of the video stream 1002 using conventional image processing techniques to find all of the image frames that include the point of interest. In one embodiment, landmarks 102 (shown in FIG. 1) appearing in images are used to facilitate the identification of image frames that include the point of interest identified by the user. FIG. 10C is a diagram illustrating the identification of a set of image frames that include a point of interest identified by a user according to one embodiment of the present invention. As shown in FIG. 10C, device 110 has identified a set 1030 of image frames (i.e., image frames 1002C-1002K) that include the point of interest identified by a user. Image frame 1002I is shown enlarged in FIG. 10C, and includes the point of interest (represented by cross hairs 1022) identified by the user. Image frames 1002C-1002H and 1002J-1002K also include the identified point of interest, but the point of interest may appear in different regions of these image frames than illustrated for frame 1002I.

In step 908 of process 900, device 110 identifies image frames that include motion at the selected point of interest. FIG. 10D is a diagram illustrating the identification of frames that show motion near a selected point of interest according to one embodiment of the present invention. As shown in FIG. 10D, device 110 has identified a subset 1032 within set 1030 that includes two image frames 1002J and 1002K, which show motion near the selected point of interest. In one embodiment, motion is detected using conventional image processing techniques by comparing successive frames to identify changes in image content from one frame to another.

In step 910 of process 900, device 110 selects an image to display from the frames identified in step 908. In one embodiment, device 110 selects the first frame 1002J from the identified subset 1032. FIG. 10E is a diagram illustrating a frame 1002J selected for display according to one embodiment of the present invention. As shown in FIG. 10E, the enlarged representation of frame 1002J shows motion (i.e., runner 1008 falling down near finish line 1010) near the selected point of interest (indicated by cross hairs 1022).

In step 912 of process 900, device 110 displays the relevant portion of the image frame 1002J identified in step 910 on display 512. Since, in one embodiment, the captured image frames 1002A-1002L have a higher resolution and a wider field of view than display 512, only a portion of the image frame 1002J identified in step 910 is displayed in step 912 in one form of the invention. FIG. 10F is a diagram illustrating the display of a relevant image portion 1040 of the image frame 1002J identified in step 910 according to one embodiment of the present invention. As shown in FIG. 10F, image portion 1040 includes the selected point of interest, and shows runner 1008 falling down near the selected point of interest.

In one form of process 900, orientation sensor 622 (shown in FIG. 6B) senses the various orientations of device 110 during capture of video stream 1002, and each image frame is associated with orientation data representing the orientation of device 110 when that frame was captured. In this embodiment, the orientation of device 110 is also sensed by sensor 622 when the user selects a point of interest in step 904. The orientation of the device 110 at the point in time when a point of interest is selected is compared with the orientations of the device 110 as image frames of the event were captured to facilitate identifying an image to display. In one embodiment, when the user selects a point of interest, the orientation of device 110 at that time is compared with previously stored orientations to identify image frames that were captured when device 110 was at a similar orientation. The orientation of device 110 when a point of interest is selected may not be exactly the same as when the image frames were originally captured, since the user may be focusing on different locations than were originally viewed.

In one embodiment, device 110 is configured to communicate with other similar devices 110 via I/O interface 612 and antenna 613. For example, if, while watching a replay of video stream, a user hits a record button (e.g., button 514C) on the device 110, device 110 stores the currently viewed image along with a link to get access to a full recording from server 118. In one embodiment, the link includes the address of the server 118 that provided the image to the original user. The user can then send the stored image and link to a friend with a similar device 110, along with a comment, such as “did you see how the runner in lane three tripped?” Thus, the friend can view the image and scroll back and forth based on spatial location in the same manner as the original user. Referee decisions are sometimes contested, and all angles of the action do not provide equal information. Since users of devices 110 may receive different views of a particular event, being able to share the different views with each other is certainly an asset for the users.

Although specific embodiments have been illustrated and described herein for purposes of description of the preferred embodiment, it will be appreciated by those of ordinary skill in the art that a wide variety of alternate and/or equivalent implementations may be substituted for the specific embodiments shown and described without departing from the scope of the present invention. Those with skill in the chemical, mechanical, electromechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

What is claimed is:

1. A method for controlling playback of a temporal stream with a user interface device, the temporal stream captured at an event site, the method comprising:
selecting a point of interest at the event site with the user interface device;
identifying a time that an action occurred at the selected point of interest;
identifying an image from the temporal stream based on the identified time; and
displaying the identified image on the user interface device.

2. The method of claim 1, and further comprising:
capturing a first image with the user interface device; and
processing the first image to identify the selected point of interest.

3. The method of claim 1, and further comprising:
sensing an orientation of the user interface device; and
identifying the selected point of interest based on the sensed orientation of the user interface device.

4. The method of claim 3, and further comprising:
sensing a position of the user interface device; and
wherein the selected point of interest is identified based on the sensed orientation and sensed position of the user interface device.

5. The method of claim 1, wherein the time that an action occurred at the selected point of interest is identified based on motion sensor information.

6. A system for controlling playback of a temporal stream captured at an event site, the method comprising:
a user interface device for selecting a point of interest at the event site;
a controller for identifying a time that motion occurred at the selected point of interest, the controller configured to identify an image from the temporal stream based on the identified time; and
the user interface device including a display for displaying the identified image.

7. The system of claim 6, and further comprising:
an image sensor in the user interface device for capturing a first image; and
wherein the controller is configured to process the first image to identify the selected point of interest.

8. The system of claim 6, and further comprising:
an orientation sensor for sensing an orientation of the user interface device when the point of interest is selected; and
wherein the controller is configured to identify the selected point of interest based on the sensed orientation of the user interface device.

9. The system of claim 8, and further comprising:
a position sensor for sensing a position of the user interface device when the point of interest is selected; and
wherein the controller is configured to identify the selected point of interest based on the sensed orientation and sensed position of the user interface device.

10. The system of claim 6, wherein the controller identifies a time that motion occurred at the selected point of interest based on information provided by at least one motion sensor.

11. A system for playing back images in a temporal stream captured at an event site, the method comprising:
means for selecting a spatial location at the event site;
means for identifying a time that motion occurred at the selected spatial location;
means for identifying an image from the temporal stream based on the identified time; and
means for displaying the identified image.

12. The system of claim 11, wherein the means for selecting a spatial location includes image sensing means for capturing a first image, the system further comprising:
means for processing the first image to identify the selected spatial location.

13. The system of claim 11, and further comprising:
orientation sensing means for sensing an orientation of the means for selecting a spatial location when the spatial location is selected; and
means for identifying the selected spatial location based on the sensed orientation.

14. The system of claim 13, and further comprising:
position sensing means for sensing a position of the means for selecting a spatial location when the spatial location is selected; and
means for identifying the selected spatial location based on the sensed orientation and sensed position.

15. The system of claim 11, wherein the means for identifying a time is configured to identify a time that motion occurred at the selected spatial location based on information provided by a means for sensing motion at the selected spatial location.

16. A method for capturing and playing back a temporal stream comprising:
capturing a temporal stream of images at an event site;
associating a time of capture with each image in the captured temporal stream;
storing location information identifying a plurality of spatial locations at the event site;
associating at least one time with each spatial location;
identifying one of the spatial locations at the event site with a user interface device;
identifying at least one image in the captured temporal stream based on the identified spatial location, the at least one time associated with the identified spatial location, and the times of capture associated with the images in the temporal stream; and
displaying an image on the user interface device based on the identified at least one image.

17. The method of claim 16, wherein the at least one time associated with each spatial location represents a time that an action occurred at that spatial location.

18. The method of claim 16, and further comprising:
associating camera orientation information with each image in-the captured temporal stream; and
wherein the identification of the at least one image is also based on the camera orientation information.

19. The method of claim 16, and further comprising:
associating camera orientation information with each image in the captured temporal stream; and
wherein the image displayed on the user interface device is synthesized based on the identified at least one image and the camera orientation information associated with the identified at least one image.

20. A method for playing back a temporal stream of images captured at an event site, each captured image including a plurality of regions and an associated time of capture, the method comprising:
providing mapping data that associates one of a plurality of spatial locations at the event site with each region of each captured image;
associating at least one time with each one of the plurality of spatial locations;
transmitting the temporal stream of images and the mapping data to a user interface device;
displaying the temporal stream of images on the user interface device;
selecting one of the plurality of spatial locations with the user interface device;
identifying at least one image in the captured temporal stream based on the selected spatial location, the at least one time associated with the selected spatial location, and the time of capture associated with the images in the temporal stream; and
displaying an image on the user interface device based on the identified at least one image.

21. The method of claim 20, wherein the step of selecting one of the spatial locations comprises:
selecting one of the plurality of regions of one of the images displayed on the user interface device; and
identifying the spatial location associated with the selected region.

22. The method of claim 20, wherein the step of selecting one of the spatial locations comprises:
displaying a virtual reality representation of the event site on the user interface device; and
sensing an orientation of the user interface device; and
identifying a spatial location based on the sensed orientation of the user interface device.

23. A method for playing back a temporal stream of images captured at an event site, each captured image including a plurality of regions and an associated time of capture, the method comprising:
associating at least one time with each one of a plurality of spatial locations at the event site;
providing mapping data that associates a time with each region of each captured image based on the times associated with the plurality of spatial locations;
transmitting the temporal stream of images and the mapping data to a user interface device;
displaying the temporal stream of images on the user interface device;
selecting one of the regions in one of the displayed images with the user interface device;
transmitting a time identifier from the user interface device, the time identifier identifying the time associated with the selected region;
identifying at least one image in the captured temporal stream based on the time identifier and the time of capture associated with the images in the temporal stream; and
displaying an image on the user interface device based on the identified at least one image.

24. A device for capturing and playing back a temporal stream comprising:
an image sensor for capturing a temporal stream of image frames at an event site and capturing an image of a point of interest at the event site, the image sensor configured to capture more image information in the image frames than viewed through the device by a user during capture of the temporal stream;
a controller for identifying image frames in the temporal stream that include the point of interest based on the captured image of the point of interest, the controller configured to process the identified image frames to identify at least one image frame that shows motion near the point of interest; and
a display for displaying an image based on the identified at least one image frame, the displayed image including the point of interest and additional image information that was not visible through the device by the user during capture of the temporal stream.

25. The device of claim 24, and further comprising:
an orientation sensor for sensing orientations of the device during capture of the temporal stream and during capture of the image of the point of interest; and
wherein the controller is configured to compare the orientation of the device during capture of the image of the point of interest with the orientations of the device during capture of the temporal stream to facilitate identifying images frames that include the point of interest.

26. A computer-readable medium having computer-executable instructions for performing a method of controlling playback of a temporal stream captured at an event site, the method comprising:
selecting a point of interest at the event site;
identifying a time that motion occurred at the selected point of interest;
identifying an image from the temporal stream based on the identified time; and
displaying the identified image.
